(19) United States
(12) Patent Application Publication
(10) Pub. No.: US 2025/0347822 A1
(43) Pub. Date: Nov. 13, 2025

(54) OBJECT DETECTION APPARATUS, OBJECT DETECTION SYSTEM, AND COMPUTER-READABLE, NON-TRANSITORY MEDIUM

(71) Applicant: PFU LIMITED, Ishikawa (JP)

(72) Inventors: Yudai ASAI, Ishikawa (JP); Masanobu HONGO, Ishikawa (JP)

(21) Appl. No.: 19/198,459

(22) Filed: May 5, 2025

(30) Foreign Application Priority Data
May 10, 2024 (JP) 2024-077090
Dec. 19, 2024 (JP) 2024-223879

(51) Int. Cl. G01V 5/22; G06T 7/62; G06T 7/70

(52) U.S. Cl. CPC G01V 5/224; G06T 7/62; G06T 7/70; G06T 2207/20132

(57) ABSTRACT

An object detection apparatus includes circuitry to acquire a multi-energy X-ray image based on a plurality of types of X-ray data from an X-ray imager, generate a first image in which a target object appears, and detect a position of the target object in the first image using a first trained model that is pretrained to output the position of the target object.

### CROSS-REFERENCE TO RELATED APPLICATIONS

This patent application is based on and claims priority pursuant to 35 U.S.C. § 119(a) to Japanese Patent Application Nos. 2024-077090, filed on May 10, 2024, and 2024-223879, filed on Dec. 19, 2024, in the Japan Patent Office, the entire disclosure of which is hereby incorporated by reference herein.

### BACKGROUND

The present disclosure relates to an object detection apparatus, an object detection system, and a computer-readable, non-transitory medium.

A technology for detecting a particular object mixed in with waste using an X-ray imager is known. For example, there is a social problem that lithium-ion batteries accidentally mixed in with waste ignite during the intermediate treatment of waste and cause fires. Currently, there is no effective automatic detection method, so manual sorting is relied upon. Waste is in a multi-layered state, and lithium-ion batteries or the like are built in products. This makes it difficult to distinguish the lithium-ion batteries based on their appearances. Accordingly, the technical difficulty of detecting lithium-ion batteries is high.

As a technology for identifying an object using the X-ray imager, a technology for pseudo-coloring an identification result based on information for identifying a substance of a dual-energy X-ray image has been proposed.

### SUMMARY

An object detection apparatus according to one aspect of the present disclosure includes circuitry. The circuitry acquires a multi-energy X-ray image based on a plurality of types of X-ray data from an X-ray imager. The circuitry generates a first image in which a target object appears. The circuitry detects a position of the target object in the first image using a first trained model that is pretrained to output the position of the target object.

An object detection system according to another aspect of the present disclosure includes the object detection apparatus according to the above aspect and an output device to notify that the position of the target object is detected by the circuitry of the object detection apparatus.

A computer-readable, non-transitory medium according to still another aspect of the present disclosure stores a computer program. The computer program causes a computer to execute a process. The process includes acquiring a multi-energy X-ray image based on a plurality of types of X-ray data from an X-ray imager. The process includes generating a first image in which a target object appears, and detecting a position of the target object in the first image using a first trained model that is pretrained to output the position of the target object

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of an overall configuration of an object detection system according to a first example;

FIG. 2 is a diagram for explaining an overview of a configuration of an X-ray imager according to the first example;

FIG. 3 is a diagram illustrating an example of a configuration of the object detection system that includes a removal device, according to the first example;

FIG. 4 is a diagram illustrating an example of a dual-energy X-ray image;

FIG. 5 is a diagram for explaining how substances are displayed differently between a single-energy X-ray image and a dual-energy X-ray image;

FIG. 6A and FIG. 6B are diagrams for explaining how an object to be detected is displayed differently between a single-energy X-ray image and a dual-energy X-ray image;

FIG. 7A to FIG. 7D are diagrams for explaining an example of an overview of an operation performed by an object detection apparatus when an object to be detected is mixed in with plastic packaging waste;

FIG. 8A to FIG. 8E are diagrams explaining an example of an overview of an operation performed by the object detection apparatus when an object to be detected is mixed in with non-combustible waste;

FIG. 9 is a diagram illustrating an example of a block configuration of the object detection system according to the first example;

FIG. 10A and FIG. 10B are diagrams for explaining processing by a first image processing unit of the object detection apparatus according to the first example;

FIG. 11A and FIG. 11B are diagrams for explaining processing by a second image processing unit of the object detection apparatus according to the first example;

FIG. 12 is a diagram illustrating an example of an image of non-combustible waste;

FIG. 13A and FIG. 13B are diagrams illustrating examples of an image of a pouch-type lithium-ion battery;

FIG. 14A and FIG. 14B are diagrams for explaining processing by a third image processing unit of the object detection apparatus according to the first example;

FIG. 15 is a diagram for explaining processing performed by a determination unit of the object detection apparatus according to the first example;

FIG. 16A and FIG. 16B are diagrams illustrating an example of a display operation by a display under control of a notification unit of the object detection apparatus according to the first example;

FIG. 17A and FIG. 17B are diagrams illustrating an example of a display operation by the display under control of the notification unit of the object detection apparatus according to the first example;

FIG. 18 is a diagram illustrating an example of an operation by a projector of irradiating a conveyed object including a target object under control of the notification unit of the object detection apparatus according to the first example;

FIG. 19 is a diagram illustrating an example of an operation by the projector of irradiating a target object under control of the notification unit of the object detection apparatus according to the first example;

FIG. 20 is a diagram illustrating an example of an operation by the projector of irradiating a position indicator of a target object under control of the notification unit of the object detection apparatus according to the first example;

FIG. 21A and FIG. 21B are diagrams illustrating how images are displayed differently due to a difference in thickness of other materials;

FIG. 22 is a diagram illustrating an example of an operation by the projector of irradiating a wide range including a target object under control of the notification unit of the object detection apparatus according to the first example;

FIG. 23 is a flowchart illustrating an example of a flow of a process by the object detection system according to the first example;

FIG. 24 is a diagram for explaining another form of a configuration of functional blocks of the object detection apparatus according to a second example; and

FIG. 25 is a diagram for explaining another form of a configuration of functional blocks of the object detection apparatus according to a third example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiment of an object detection apparatus, an object detection system, an object detection method, and a program disclosed in the present application are described below in detail with reference to the drawings. The technology of the present disclosure, however, is not limited to the following description, and the elements in the following description include elements that may be easily conceived by those skilled in the art, elements being substantially the same, and elements being within the range of equivalency. Various omissions, substitutions, changes, and combinations of the elements may be made without departing from the gist of the following embodiment.

### First Example

### Overall Configuration and Operation of Object Detection System

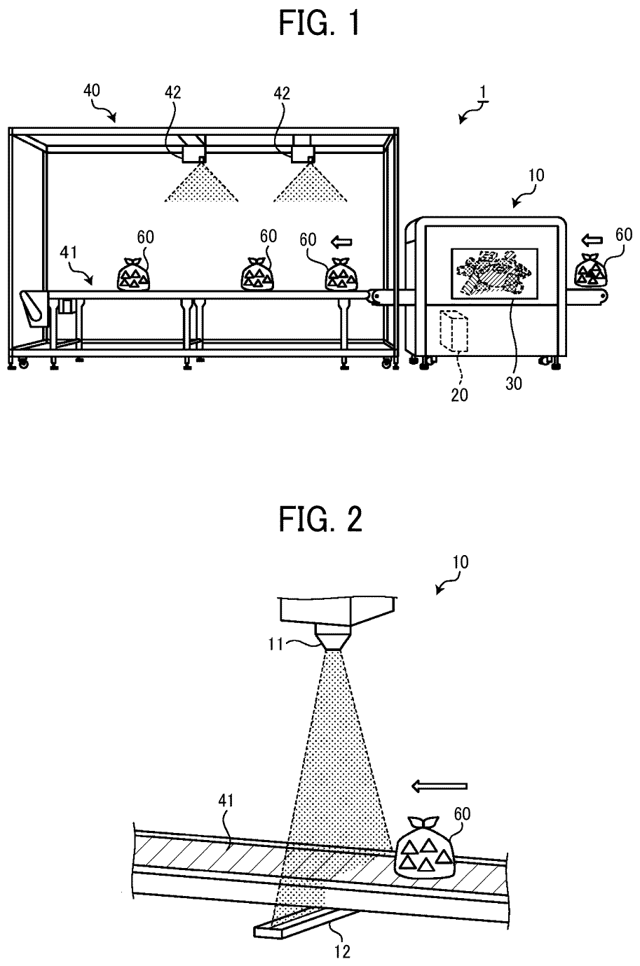

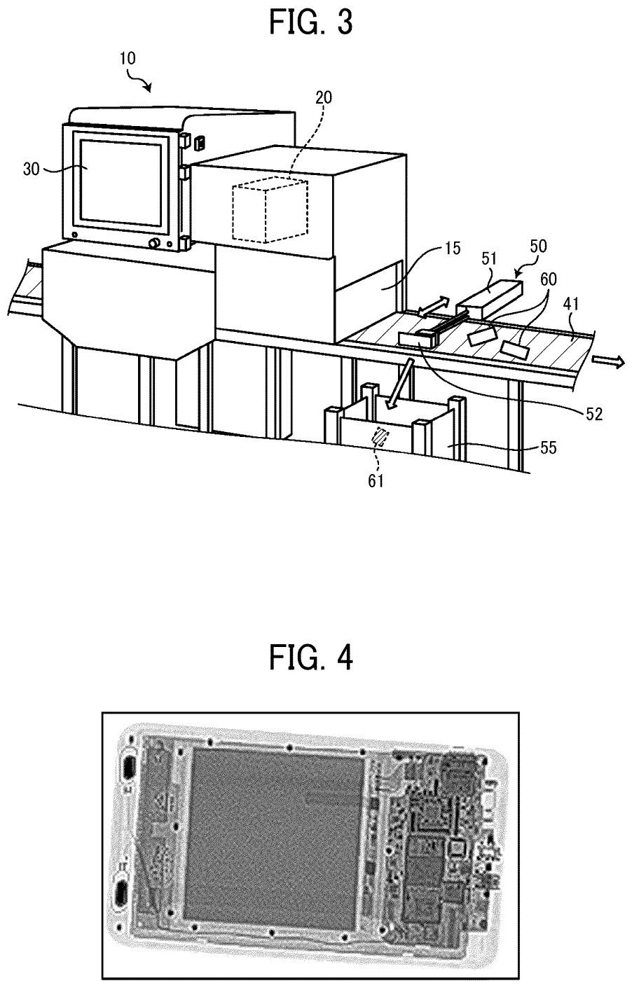

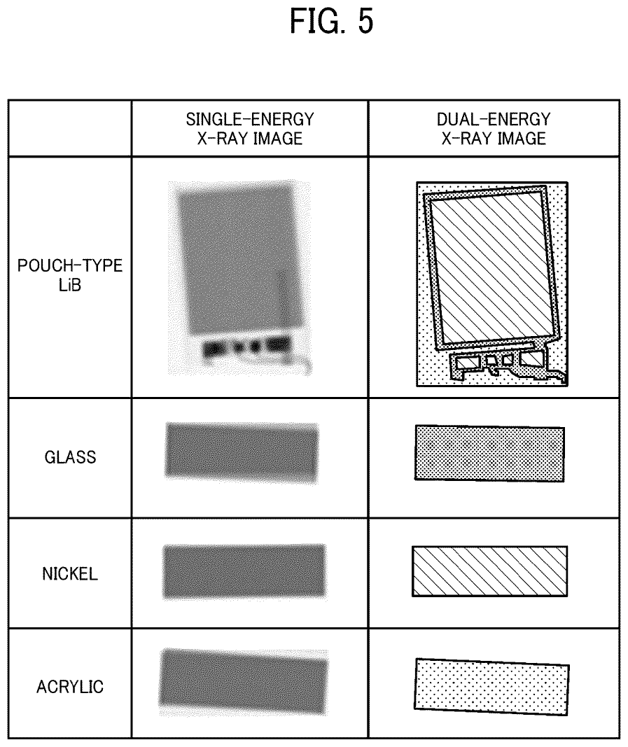

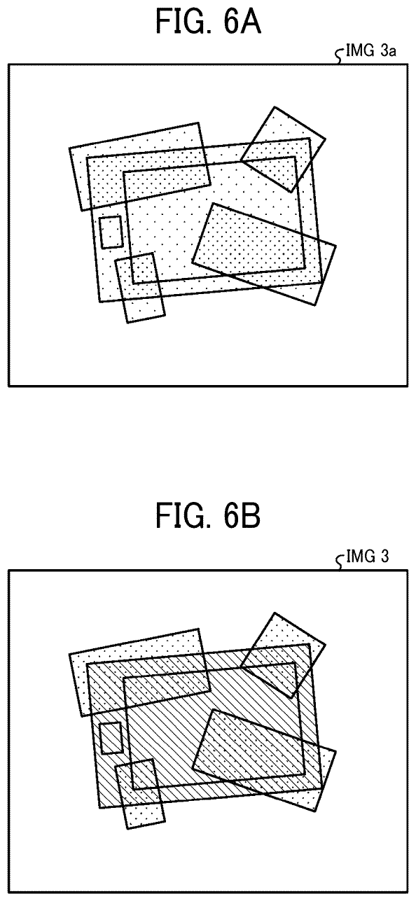

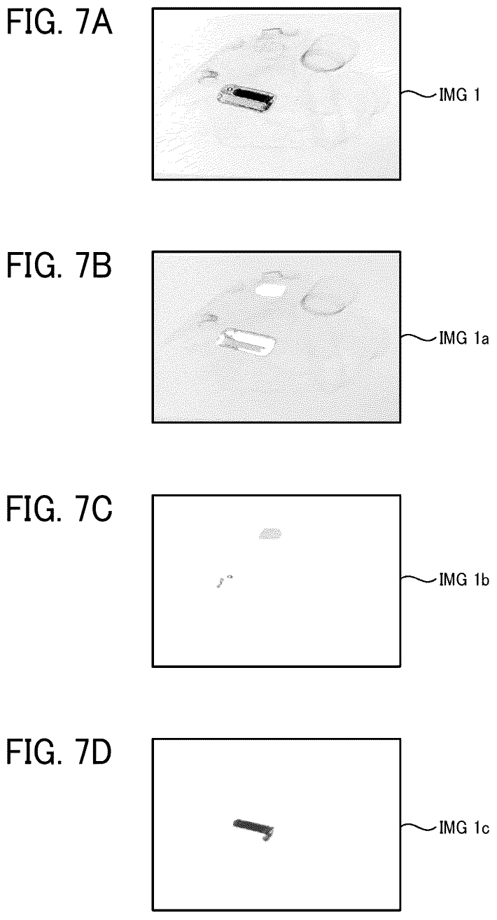

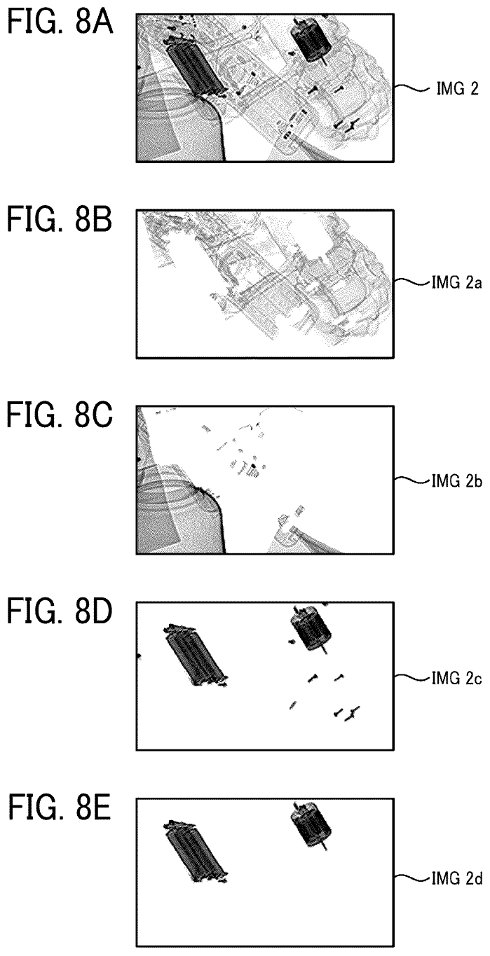

FIG. 1 is a diagram illustrating an example of an overall configuration of an object detection system 1 according to a first example. FIG. 2 is a diagram for explaining an overview of a configuration of an X-ray imager 10 according to the first example. FIG. 3 is a diagram illustrating an example of a configuration of the object detection system 1 that includes a removal device 50, according to the first example. FIG. 4 is a diagram illustrating an example of a dual-energy X-ray image. FIG. 5 is a diagram for explaining how substances are displayed differently between a single-energy X-ray image and a dual-energy X-ray image. FIG. 6A and FIG. 6B are diagrams for explaining how an object to be detected is displayed differently between a single-energy X-ray image and a dual-energy X-ray image. FIG. 7A to FIG. 7D are diagrams for explaining an overview of an operation performed by an object detection apparatus 20 when an object to be detected is mixed in with plastic packaging waste. FIG. 8A to FIG. 8E are diagrams explaining an overview of an operation performed by the object detection apparatus 20 when an object to be detected is mixed in with non-combustible waste. An overall configuration and an overall operation of the object detection system 1 according to the present example are described below with reference to FIG. 1 to FIG. 8E.

The object detection system 1 illustrated in FIG. 1 is a system for detecting a particular object to be detected in a conveyed object 60 using a dual-energy X-ray image obtained by imaging the conveyed object 60 with an X-ray imager 10. In the following description, the particular object to be detected may be referred to as a “target object.” As illustrated in FIG. 1, the object detection system 1 includes the X-ray imager 10, the object detection apparatus 20, a display 30, and a conveyor 40.

The X-ray imager 10 is an apparatus that generates a dual-energy X-ray image having pixel values that distinguish between substances (materials). Specifically, the X-ray imager 10 derives a ratio of attenuation amounts of two types of X-rays of high energy and low energy emitted from an X-ray source passing through an object such as the conveyed object 60 conveyed through the X-ray imager 10. The X-ray imager 10 generates a dual-energy X-ray image having pixel values that distinguish between substances (materials) such as effective atomic numbers based on the ratio of the attenuation amounts. In other words, the pixel values of pixels forming the dual-energy X-ray image can be dealt as information for identifying materials forming the conveyed object 60. In the following description, generating the dual-energy X-ray image of the conveyed object 60 by the X-ray imager 10 through the above-described process may be expressed as the X-ray imager 10 imaging the conveyed object 60. As illustrated in FIG. 2, the X-ray imager 10 includes an X-ray source 11 and an X-ray sensor 12.

In the present disclosure, the effective atomic number refers to an average atomic number in a substance including a plurality of atoms. For example, the effective atomic number can be calculated by the method described below. First, for a material having a thickness x, the relation represented by the following Equation (1) is satisfied, where the incident X-ray intensity corresponding to energy E is I₀(E), the intensity of X-ray that has passed through is I(E), and the linear attenuation coefficient is μ(E).

$$I ( E ) = {I}_{0} ( E ) exp [ - μ ( E ) x ] \qquad Equation ( 1 )$$

From Equation (1), the following Equation (2) is derived.

$$μ ( E ) x = - ln [ I ( E ) / {I}_{0} ( E ) ] \qquad Equation ( 2 )$$

The gradient G calculated by the following Equation (3) for the two different energies E₁ and E₂ is a value independent of the thicknesses x.

$$G = ln [ μ ( E 1 ) / μ ( E 2 ) ] \qquad Equation ( 3 )$$

The value of the effective atomic number Z_{eff} can be estimated by preliminarily storing the values of the gradient G for the two energies of interest of each atom in a database and comparing the values in the database with the actually measured value of the gradient. Specifically, the value of the effective atomic number Z_{eff} can be calculated by the following Equation (4), where two closest effective atomic numbers (integers) corresponding to the measured value of the gradient are Z₁ and Z_{2,} the gradients corresponding to the Z₁ and Z₂ are G₁ and G₂, and the measured value of the gradient is G.

$${Z}_{eff} = {Z}_{1} + ( G - {G}_{1} ) ( {Z}_{2} - {Z}_{1} ) / ( {G}_{2} - {G}_{1} ) \qquad Equation ( 4 )$$

As illustrated in FIG. 2, the X-ray source 11 is a device located in the upper portion inside the X-ray imager 10 and emits X-rays downward to the conveyed object 60 conveyed by a conveyance device 41 described later. The X-ray source 11 may switch X-rays to be emitted between two types of X-rays, e.g., high-energy X-rays and low-energy X-rays. The X-ray source 11 may be configured by two X-ray sources, one for emitting high-energy X-rays and the other for emitting low-energy X-rays. The X-ray source 11 emits X-rays at a tube voltage in the range of, for example, 100 to 160 kV. As a result, even when the conveyed object 60 contains a metal material, many features remain on the image, making it easier to detect a target object such as a lithium-ion battery. Although the X-ray source 11 is located in the upper portion inside the X-ray imager 10 in FIG. 2, the present disclosure is not limited thereto. The X-ray source 11 may be located in the lower portion inside the X-ray imager 10.

As illustrated in FIG. 2, the X-ray sensor 12 is a sensor located such that the conveyed object 60 conveyed by the conveyance device 41 is between the X-ray source 11 and the X-ray sensor 12 and detects the X-rays emitted from the X-ray source 11. Thus, the X-ray sensor 12 detects two types of X-rays of high energy and low energy emitted from the X-ray source 11, and the ratio of the respective attenuation amounts is obtained. Although the X-ray sensor 12 illustrated in FIG. 2 is a line sensor, the present disclosure is not limited thereto. The X-ray sensor 12 may be, for example, an area sensor.

Although in the above description, the X-ray source 11 emits X-rays of high energy and low energy, the present disclosure is not limited thereto. The X-ray source 11 may emit X-rays of single energy and the X-ray sensor 12 may switch the sensitivity characteristics of the incident X-rays to obtain two types of X-ray data. In this case, the X-ray sensor 12 may be configured by two sensors having different sensitivity characteristics. Each of the two sensors detects X-rays of a single energy emitted from the X-ray source 11. When the X-ray source 11 is configured by two X-ray sources, one for emitting high-energy X-rays and the other for emitting low-energy X-rays, the X-ray imager 10 may include two X-ray sensors 12 that respectively detect X-rays of two types of energy. In other words, in any of the above-described configurations of the X-ray source 11 and the X-ray sensor 12, two types of X-ray data are obtained, and thus a dual-energy X-ray image is obtained based on the ratio of the attenuation amounts of the two types of X-rays.

The X-ray imager 10 may output a pseudo-colored image as the dual-energy X-ray image, as illustrated in FIG. 4. For example, as a coloring method for pseudo coloring, the X-ray imager 10 may assign blue, green, and red colors according to an area of a coordinate system represented by the attenuation amount of low-energy X-rays on the horizontal axis and the attenuation amount of high-energy X-rays on the vertical axis and replace pixel values with color values of the respective colors to perform pseudo coloring. Thus, the area of the same color system indicates a material of the same type. In this case, when a particular coordinate is determined in the coordinate system, the ratio of the attenuation amounts of two types of X-rays of high energy and low energy is also determined. The hue and saturation for pseudo-coloring may be determined based on the position of the coordinate system, and the intensity or attenuation amount of high-energy X-rays may be used for lightness. In the area of material of the same type, the relative size of the effective atomic number may be expressed by making the pixel value (color value) closer to black as the effective atomic number increases. Another example of a coloring method for pseudo coloring is to compare a value of the ratio of logarithms of attenuation amounts of high-energy and low-energy X-rays with an appropriate threshold. Still another example of a coloring method for pseudo coloring is to refer to a predefined look-up table. Further, the X-ray imager 10 is not limited to outputting a pseudo-colored image as the dual-energy X-ray image. The X-ray imager 10 may output two monochrome images (a high-energy image and a low-energy image).

The superiority of using a dual-energy X-ray image by the X-ray imager 10 to detect a target object, rather than a single-energy X-ray image generated based on the attenuation amount when X-rays of a single energy emitted from an X-ray source pass through the target object is described below. FIG. 5 is a schematic diagram illustrating images obtained by imaging a pouch-type lithium-ion battery-integrated device, a plate-shaped glass, a plate-shaped nickel, and a plate-shaped acrylic with single-energy X-rays and dual-energy X-rays, respectively. As illustrated in FIG. 5, for the single-energy X-ray image, there is almost no difference in images between materials of glass, nickel, and acrylic. By contrast, in a dual-energy X-ray image, different colors are given to respective materials. Accordingly, the dual-energy X-ray image makes it easier to distinguish a target object from non-combustible waste of a different material having a similar appearance to the target object. For example, as illustrated in FIG. 5, since the pouch-type lithium-ion battery is mostly made of inorganic materials, the pouch-type lithium-ion battery can be distinguished from rectangular non-combustible waste made of organic materials or light metals such as a rectangular plastic product, rectangular glass, and a rectangular mirror.

FIG. 6A is a diagram illustrating how a target object is displayed in the single-energy X-ray image. FIG. 6B is a diagram illustrating how a target object is displayed in the dual-energy X-ray image. Assuming that a target object and non-combustible waste overlap with each other, since the single-energy X-ray image is a monochrome image as in a single-energy X-ray image IMG 3a illustrated in FIG. 6A, the effects of the overlapping non-combustible waste appear in a single color channel. By contrast, when objects that are made of different material from the target object overlap with the target object in the dual-energy X-ray image as in a dual-energy X-ray image IMG 3 illustrated in FIG. 6B, the effects appear in different color channels of a color image. Accordingly, the effects are less than those in the single-energy X-ray image. This enhances the detection accuracy of the target object compared to the single-energy X-ray image.

In the above description, a dual-energy X-ray image based on two types of X-ray data is used for distinguishing substances (materials). However, the present disclosure is not limited thereto. A multi-energy X-ray image based on two or more types of X-ray data may be used. In the following description, it is assumed that the X-ray imager 10 generates a dual-energy X-ray image based on two types of X-ray data.

The object detection apparatus 20 is an information processing apparatus to detect a particular object such as a lithium-ion battery from the conveyed object 60 conveyed by the conveyance device 41 using a dual-energy X-ray image generated by the X-ray imager 10. The object detection apparatus 20 is a typical information processing apparatus such as a personal computer (PC) or a workstation. The object detection apparatus 20 includes a central processing unit (CPU) or a graphics processing unit (GPU), a random-access memory (RAM), an auxiliary memory, and an input/output interface circuit. As illustrated in FIG. 1, the object detection apparatus 20 is, for example, built in a housing of the X-ray imager 10. The object detection apparatus 20 may be located outside the housing of the X-ray imager 10.

Specifically, the object detection apparatus 20 detects a target object by performing particular image processing on the dual-energy X-ray image of the conveyed object 60 acquired from the X-ray imager 10. FIG. 7A is a diagram illustrating a dual-energy X-ray image IMG 1 when the conveyed object 60 is plastic packaging waste. The dual-energy X-ray image IMG 1 is pseudo-colored by giving, for example, red to organic materials such as plastic bags, green to light metals such as aluminum, ceramic, or glass, and blue to inorganic materials such as batteries. FIG. 7B is a diagram illustrating an image IMG la obtained by deleting components of the light metals and inorganic materials from the dual-energy X-ray image IMG 1, leaving only the organic materials. FIG. 7C is a diagram illustrating an image IMG 1b obtained by deleting components of the organic materials and inorganic materials from the dual-energy X-ray image IMG 1, leaving only the light metals. FIG. 7D is a diagram illustrating an image IMG 1c obtained by deleting components of the organic materials and the light metals from the dual-energy X-ray image IMG 1, leaving only the inorganic materials. When the target object to be detected is, for example, a lithium-ion battery, the object detection apparatus 20 performs image processing on the dual-energy X-ray image to delete components other than the inorganic materials including the target object, that is, image processing to generate an image of components of the inorganic materials including the target object as described above with reference to FIG. 7D. The object detection apparatus 20 detects the target object using the generated image including the target object.

FIG. 8A is a diagram illustrating a dual-energy X-ray image IMG 2 when the conveyed object 60 is non-combustible waste. The dual-energy X-ray image IMG 2 is pseudo-colored by giving, for example, red to organic materials such as small appliances or remote controllers, green to light metals such as glass bottles or plates, and blue to inorganic materials such as batteries. FIG. 8B is a diagram illustrating an image IMG 2a obtained by deleting components of the light metals and inorganic materials from the dual-energy X-ray image IMG 2, leaving only the organic materials. FIG. 8C is a diagram illustrating an image IMG 2b obtained by deleting components of the organic materials and inorganic materials from the dual-energy X-ray image IMG 2, leaving only the light metals. FIG. 8D is a diagram illustrating an image IMG 2c obtained by deleting components of the organic materials and the light metals from the dual-energy X-ray image IMG 2, leaving only the inorganic materials. When the target object to be detected is, for example, a lithium-ion battery, the object detection apparatus 20 performs image processing on the dual-energy X-ray image to delete components other than the inorganic materials including the target object, that is, image processing to generate an image of components of the inorganic materials including the target object as described above with reference to FIG. 8D. Further, the object detection apparatus 20 performs image processing to delete connected components smaller than a preset area (a preset threshold area) from the generated image IMG 2c illustrated in FIG. 8D, thereby obtaining an image IMG 2d illustrated in FIG. 8E. Thus, the detection processing of the target object can be performed after removing components that may result in noise. Since the area of a screw is about 40 pixels, the area of a cylindrical lithium-ion battery is about 650 pixels, and the area of a pouch-type lithium-ion battery is about 400 to 500 pixels, when a target object is a lithium-ion battery, the preset area as a threshold is, for example, about 100 to 200 pixels. The object detection apparatus 20 detects the target object using the image from which the noise is removed and that includes the target object.

The details of the image processing performed by the object detection apparatus 20 described above as an example with reference to in FIG. 7A to FIG. 7D and FIG. 8A to FIG. 8E are described later.

The display 30 displays a pseudo-colored dual-energy X-ray image generated by the X-ray imager 10 and the most recent detection result by the object detection apparatus 20 under control of the object detection apparatus 20. Examples of the display 30 include a liquid crystal display (LCD) and an organic electroluminescence (EL) display. As illustrated in FIG. 1, the display 30 is located, for example, on the side face of the housing of the X-ray imager 10. The display 30 of the object detection system 1 facilitates checking the detection result, etc., even in a place highly illuminated. The display 30 may display, for example, the number of detections during a certain time period in the past, the operation time of the object detection system 1, or the estimated current position of the target object detected by the object detection apparatus 20, under control of the object detection apparatus 20. The display 30 may be provided separately from the X-ray imager 10, rather than being located on the side face of the housing of the X-ray imager 10.

The conveyor 40 is a facility for conveying the conveyed object 60 imaged by the X-ray imager 10 in a particular direction. As illustrated in FIG. 1, the conveyor 40 includes the conveyance device 41 and a projector 42.

As illustrated in FIG. 1, the conveyance device 41 is a device that conveys the conveyed object 60 imaged by the X-ray imager 10 by, for example, a belt conveyor. As illustrated in FIG. 1, the conveyance device 41 penetrates through the inside of the X-ray imager 10 and conveys the conveyed object 60 to pass through the inside of the X-ray imager 10.

The projector 42 is a projection device that is located under the upper face of a frame forming the outer shape of the conveyor 40 and emits projection light to the conveyed object 60 for which the X-ray imager 10 detects a target object among the conveyed objects 60 conveyed by the conveyance device 41. As described above, the projector 42 emits projection light directly to the conveyed object 60 for which the target object is detected. This achieves high recognizability and makes the work of an operator easier. The number of the projectors 42 is not limited to two as illustrated in FIG. 1. One or three or more projectors may be provided. In this case, by using multiple projectors 42 and dividing the range of the position of the conveyed object 60 to be irradiated by each of the projectors 42, a wider range can be irradiated than when one projector 42 is provided. The operation performed by the projector 42 is described later.

The display 30 and the projector 42 are examples of an output device according to the present disclosure. The object detection system 1 does not have to include both the display 30 and the projector 42. The object detection system 1 may include either the display 30 or the projector 42. The object detection system 1 may include another type of the output device such as a patrol lamp (signal lamp) that operates when the target object is detected or a speaker that outputs an alarm sound when the target object is detected, instead of or in addition to the display 30 or the projector 42. The advantage of the patrol lamp is that the detection result can be easily checked even in a place highly illuminated. The advantage of the speaker is that the detection result can be recognized by sound, making the work easier.

As illustrated in FIG. 3, the object detection system 1 may include the removal device 50 downstream from the X-ray imager 10 in the conveying direction. The removal device 50 removes a target object 61 to be detected when the conveyed object 60 that passes through the inside of the X-ray imager 10 via the conveyance device 41 and comes out from an opening 15 includes the target object 61 or when the conveyed object 60 itself is the target object 61. As illustrated in FIG. 3, the removal device 50 is a pusher device that removes the target object 61 from the conveyance path by moving a pusher 52 described below in a direction perpendicular to the conveying direction of the target object 61. As illustrated in FIG. 3, the removal device 50 includes a body 51 and the pusher 52. The body 51 is a portion that includes a built-in actuator such as a motor or an air cylinder that moves the pusher 52 in the direction perpendicular to the conveying direction. The pusher 52 is a member that is moved by the body 51 in the direction perpendicular to the conveying direction to drop the target object 61 into a basket 55 or the like outside the conveyance path. As described above, since the object detection system 1 includes the removal device 50, the detected target object 61 can be automatically removed from the conveyance path without the need for an operator to manually remove the target object 61. The removal device 50 is not limited to the pusher device as illustrated in FIG. 3. Other examples of the removal device include a diverter that dynamically switches the conveying direction of the conveyance device 41, or a robot arm that is located beside the conveyance path and picks up and places the target object 61. The advantage of including the pusher device or the diverter as the removal device 50 is that it saves space and cost. The advantage of including the robot arm as the removal device 50 is that it can remove the target object 61 with pinpoint precision.

### Block Configuration of Object Detection System and Operation by Object Detection System

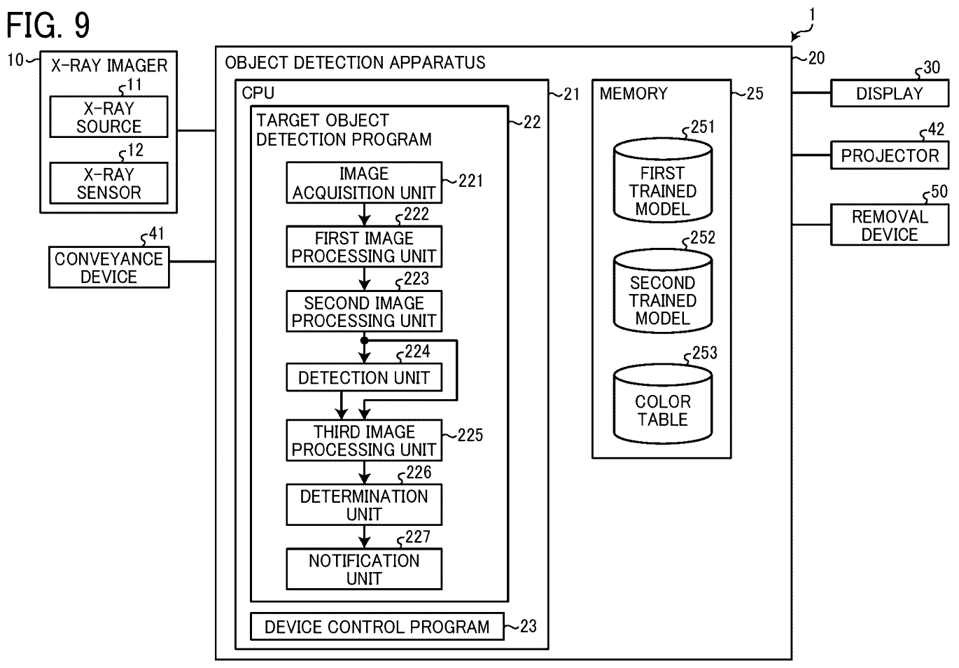

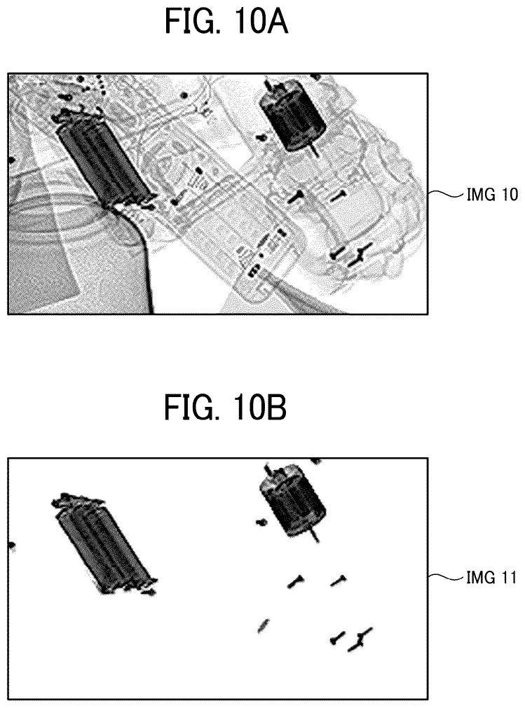

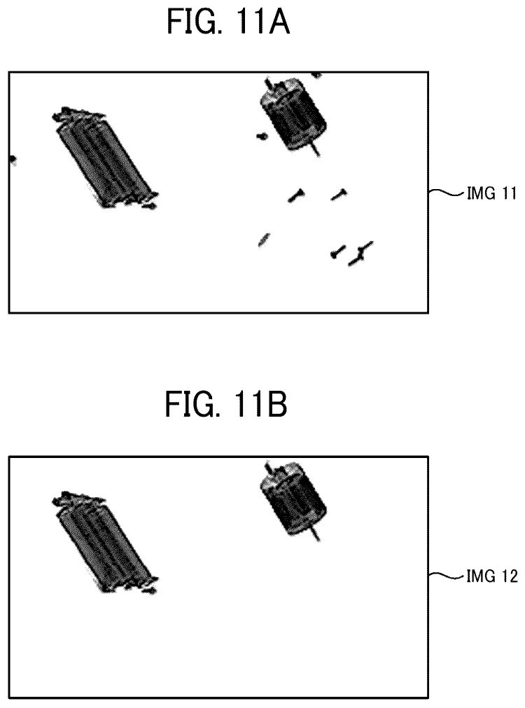

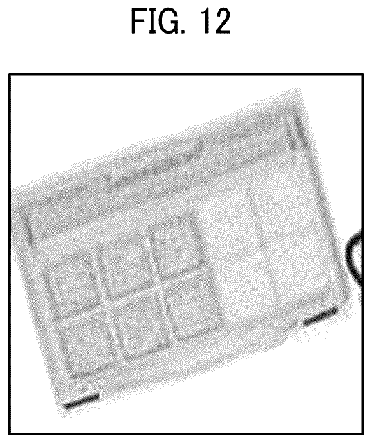

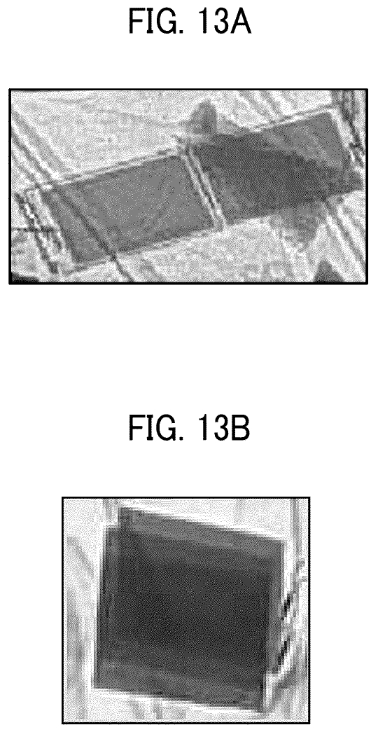

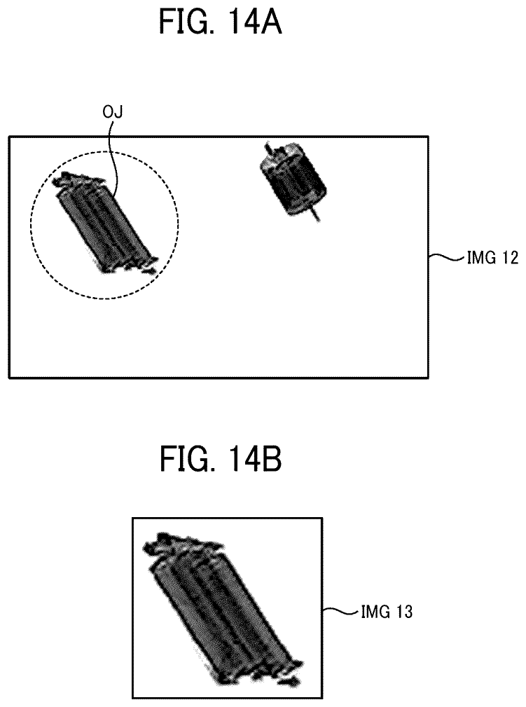

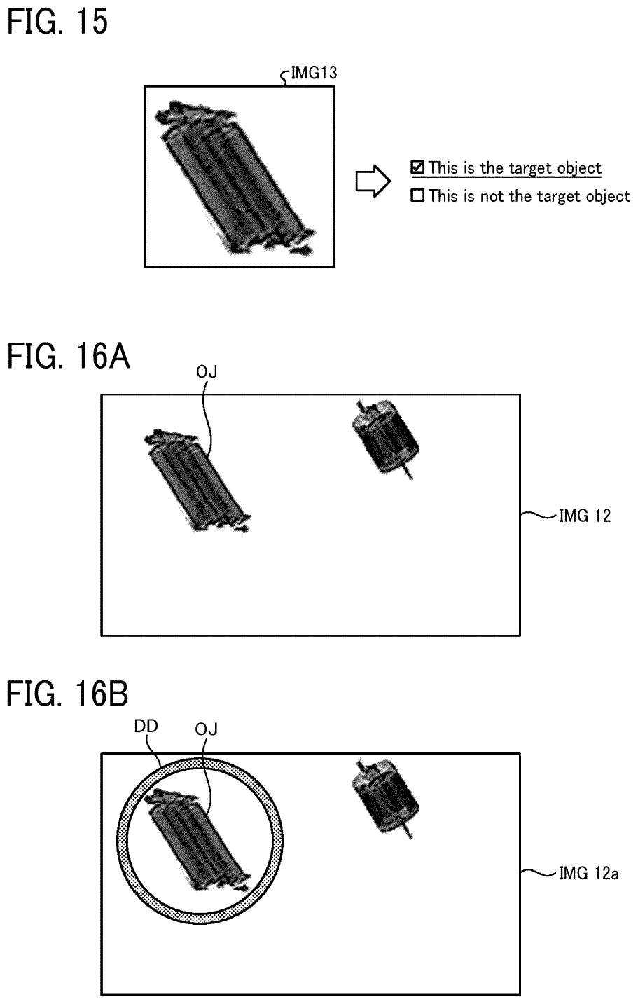

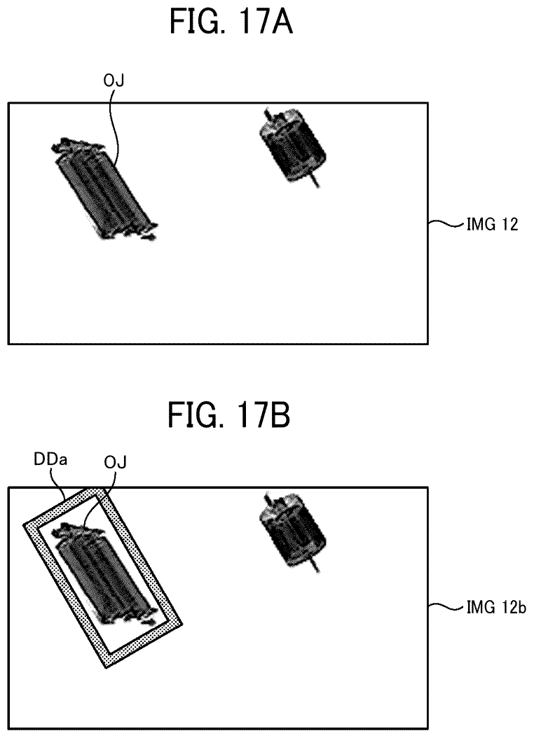

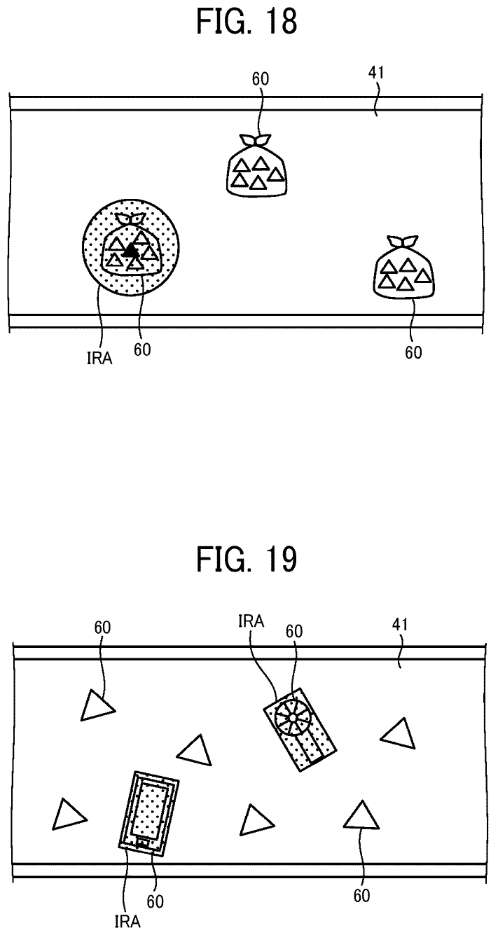

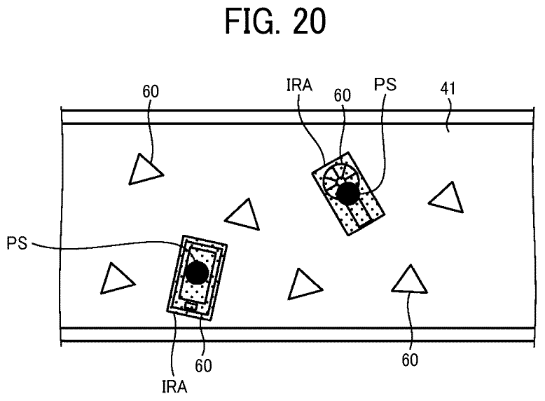

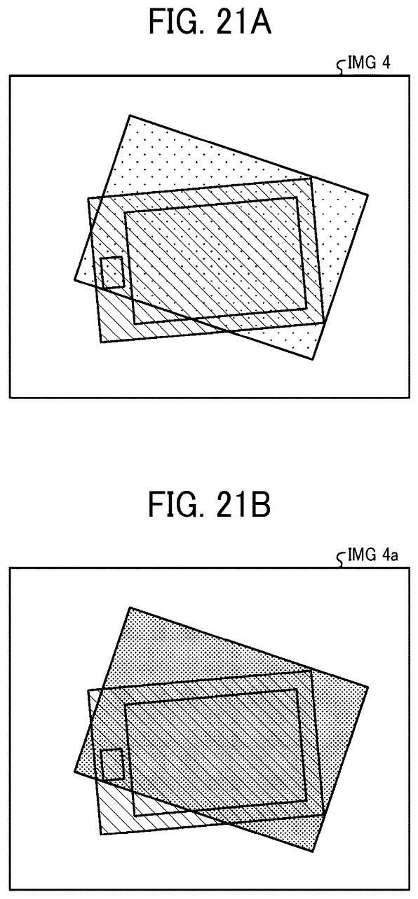

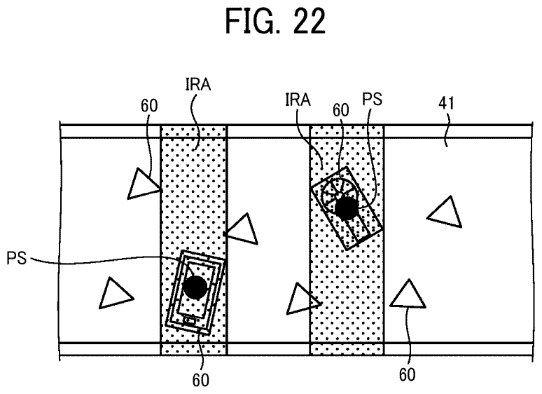

FIG. 9 is a diagram illustrating an example of a block configuration of the object detection system 1 according to the first example. FIG. 10A and FIG. 10B are diagrams for explaining processing by a first image processing unit 222 of the object detection apparatus 20 according to the first example. FIG. 11A and FIG. 11B are diagrams for explaining processing by a second image processing unit 223 of the object detection apparatus 20 according to the first example. FIG. 12 is a diagram illustrating an example of an image of non-combustible waste. FIG. 13A and FIG. 13B are diagrams illustrating examples of an image of a pouch-type lithium-ion battery. FIG. 14A and FIG. 14B are diagrams for explaining processing by a third image processing unit 225 of the object detection apparatus 20 according to the first example. FIG. 15 is a diagram for explaining processing performed by a determination unit 226 of the object detection apparatus 20 according to the first example. FIG. 16A and FIG. 16B are diagrams illustrating an example of a display operation by the display 30 under control of a notification unit 227 of the object detection apparatus 20 according to the first example. FIG. 17A and FIG. 17B are diagrams illustrating an example of a display operation by the display 30 under control of the notification unit 227 of the object detection apparatus 20 according to the first example. FIG. 18 is a diagram illustrating an example of an operation by the projector 42 of irradiating a conveyed object including a target object under control of the notification unit 227 of the object detection apparatus 20 according to the first example. FIG. 19 is a diagram illustrating an example of an operation by the projector 42 of irradiating a target object under control of the notification unit 227 of the object detection apparatus 20 according to the first example. FIG. 20 is a diagram illustrating an example of an operation by the projector 42 of irradiating a position indicator of a target object under control of the notification unit 227 of the object detection apparatus 20 according to the first example. FIG. 21A and FIG. 21B are diagrams illustrating how images are displayed differently due to a difference in thickness of other materials. FIG. 22 is a diagram illustrating an example of an operation by the projector 42 of irradiating a wide range including a target object under control of the notification unit 227 of the object detection apparatus 20 according to the first example. A block configuration of the object detection system 1 and an operation by the object detection system I according to the present example are described below with reference to FIG. 9 to FIG. 22.

As illustrated in FIG. 9, the object detection apparatus 20 of the object detection system 1 includes an image acquisition unit 221, the first image processing unit 222, the second image processing unit 223, a detection unit 224, the third image processing unit 225, the determination unit 226, the notification unit 227, and a memory 25. The image acquisition unit 221, the first image processing unit 222, the second image processing unit 223, the detection unit 224, the third image processing unit 225, the determination unit 226, and the notification unit 227 are implemented by the CPU 21 of the object detection apparatus 20 executing a target object detection program 22. A device control program 23 is a program executed by the CPU 21. The CPU 21 controls the operation of the X-ray imager 10 by executing the device control program 23. The target object detection program 22 and the device control program 23 are stored in, for example, the memory 25. The CPU 21 reads the programs onto a main memory and executes the programs. As illustrated in FIG. 9, the memory 25 further stores a first trained model 251, a second trained model 252, and a color table 253.

The image acquisition unit 221 is a functional unit that acquires a dual-energy X-ray image of the conveyed object 60 captured by the X-ray imager 10 via an interface circuit. The image acquisition unit 221 outputs the acquired dual-energy X-ray image to the first image processing unit 222. In other words, the image acquisition unit 221 acquires a multi-energy X-ray image based on multiple types of X-ray data from an X-ray imager. The first image processing unit 222 is a functional unit that generates an image in which a target object appears by performing image processing on the dual-energy X-ray image acquired by the image acquisition unit 221. This generated image of the target object may include information relating to color, edges, texture, and shape. For example, the first image processing unit 222 deletes components of other materials than the material including the target object from a dual-energy X-ray image IMG 10 Illustrated in FIG. 10A as described above with reference to FIG. 7A to FIG. 7D and FIG. 8A to FIG. 8E to generate an image IMG 11 illustrated in FIG. 10B including information of the target object.

The first image processing unit 222 may refer to the color table 253 stored in the memory 25 and generate an image including information of the target object from the dual-energy X-ray image using the color table 253. The color table 253 is a table that associates materials with ranges of pixel values of a dual-energy X-ray image. The first image processing unit 222 can obtain an image including information of the target object by extracting pixel values in the range associated with the material of the target object in the color table 253 from the dual-energy X-ray image. The color table 253 is an example of “association information” according to the present disclosure.

The first image processing unit 222 outputs the generated image including the information of the target object to the second image processing unit 223. In other words, the first image processing unit 222 generates a first image by image processing.

The second image processing unit 223 is a functional unit that performs image processing for deleting connected components smaller than a preset area from the image generated by the first image processing unit 222. For example, the second image processing unit 223 deletes connected components smaller than a preset area from the image IMG 11 illustrated in FIG. 11A as described above with reference to FIG. 8A to FIG. 8E to obtain an image IMG 12 illustrated in FIG. 11B. Thus, a portion that becomes noise in target object detection processing by the detection unit 224 is deleted. This reduces the risk of erroneous detection. The second image processing unit 223 outputs the image obtained as a result of the image processing to the detection unit 224 and the third image processing unit 225.

The second image processing unit 223 may determine whether the number of connected components is one or more in the image generated by the first image processing unit 222 and the area of the connected component is equal to or larger than the preset area. In other words, the second image processing unit 223 may determine whether the number of connected components is at least one in the image generated by the first image processing unit 222 and whether an aggregate area of the connected components is equal to or larger than the preset threshold area. Here, connected components refer to a set of adjacent pixels with the same value, obtained using image processing algorithms known in the art. When the determination result indicates that the number of connected components is one or more (at least one) and the aggregate area of the connected components is equal to or larger than the preset threshold area, the second image processing unit 223 may perform the image processing for deleting the connected components smaller than the preset threshold area. When the number of connected components is zero or the area of any connected component exceeds the threshold, the detection processing by the detection unit 224 can be omitted. That is because it is determined that the target object is apparently not conveyed in the conveyance device 41. This processing reduces processing load.

The detection unit 224 is a functional unit that detects the position of the target object from the image obtained as a result of the image processing by the second image processing unit 223 by using the first trained model 251 that is pretrained to output the position of the target object and stored in the memory 25. The position of the target object indicates, for example, the position coordinates of the target object in the dual-energy X-ray image, i.e., the image obtained as a result of the image processing by the second image processing unit 223.

The first trained model 251 is a trained model that is pretrained by machine learning using an image generated by the image processing by the second image processing unit 223 as training data to output the position of the target object (e.g., the center coordinates in the image), the size of the targe object (e.g., the width and height in the image), the angle of the target object (e.g., the angle of a straight line in the longitudinal direction of the target object with respect to a horizontal line (X-axis)), and the type of the target object when the target object is detected in the image. Accordingly, by inputting the image obtained as a result of the image processing by the second image processing unit 223 to the first trained model 251, the detection unit 224 can obtain the position, size, angle, and type of the target object as an output when the target object is detected in the image. The first trained model 251 is obtained by pretraining using at least one of the shape of the target object in the dual-energy X-ray image, the positional relationship between the components of the target object and the exterior of the target object, the attenuation amount of X-ray, and the material information as a feature. In other words, the first trained model may be a pretrained model using at least one of a shape, an X-ray attenuation amount, or material information of the target object in a multi-energy X-ray image as a feature.

When the first trained model 251 is a model trained by, for example, a convolutional neural network, color information is also used. However, since local features such as edges and texture are more important, it is useful to delete other materials that are similar in appearance, excluding color, to the target object in the image by the first image processing unit 222 to reduce erroneous detection. For example, when the target object is a pouch-type lithium-ion battery that is mostly made of inorganic material, non-combustible waste that has a shape similar to that of the pouch-type lithium-ion battery but does not contain inorganic material as illustrated in FIG. 12 is deleted by the processing by the first image processing unit 222.

When the first trained model 251 is a model trained by a convolutional neural network specifically for the purpose of object detection, scale invariance is typically important. For this reason, the model is designed and trained so that it can detect an object ranging from small to large that has the same characteristic. As a result, small non-combustible waste having a similar overall shape may be erroneously detected as a lithium-ion battery as the target object. In this case, by deleting the connected components smaller than the preset area as noise by the processing by the second image processing unit 223, a metal piece or the like that is unthinkably small for a lithium-ion battery is deleted. This reduces the risk of erroneous detection due to such non-combustible waste. Although the determination can be made during post-processing based on the size included in the detection result by the detection unit 224, the number of detections can be reduced by processing the original image. This leads to advantage in terms of processing performance. For example, some post-processing of an object detection model takes time depending on the number of detected objects, and this processing time is affected.

The detection unit 224 outputs the detection result to the third image processing unit 225.

Instead of inputting the entire image generated by the image processing by the second image processing unit 223 to the first trained model 251, the detection unit 224 may divide the image into multiple small images and input the small images to the first trained model 251 and obtain the detection result by integrating outputs from the first trained model 251. The training data used for obtaining the first trained model 251 is not limited to the image generated by the image processing by the second image processing unit 223. The first trained model 251 may be a model that is pretrained by using the dual-energy X-ray image or the image generated by the image processing by the first image processing unit 222 as training data. The first trained model 251 is not limited to outputting the position, size, angle, and type of the target object. The first trained model 251 may output at least one of the position, size, angle, and type of the target object.

The third image processing unit 225 is a functional unit that crops a surrounding image including the target object and a surrounding portion of the target object from the image generated by the image processing by the second image processing unit 223 based on the detection result (e.g., the position and the size) of the target object detected by the detection unit 224. For example, the third image processing unit 225 crops the surrounding image (e.g., a cropped image IMG 13 illustrated in FIG. 14B) including an object OJ (e.g., a lithium-ion battery in the present example) and the surrounding portion of the object OJ from the image IMG 12 illustrated in FIG. 14A generated by the image processing by the second image processing unit 223 based on the detection result (the position and the size of the object OJ) detected by the detection unit 224.

Although in the example illustrated in FIG. 14, the surrounding image is cropped as a rectangular image, the shape of the image to be cropped is not limited to rectangular. For example, the third image processing unit 225 may crop a surrounding image having a shape along the outer shape of the target object using the angle of the target object detected by the detection unit 224.

The third image processing unit 225 outputs the cropped surrounding image to the determination unit 226. In other words, the third image processing unit 225 crops a second image.

The determination unit 226 is a functional unit that determines whether the surrounding image cropped by the third image processing unit 225 includes the target object using the second trained model 252 stored in the memory 25. For example, as illustrated in FIG. 15, the determination unit 226 determines whether the target object (a lithium-ion battery in the present example) is included in the cropped IMG 13 cropped by the third image processing unit 225 using the second trained model 252.

The second trained model 252 is a trained model that is pretrained by machine learning using a dual-energy X-ray image captured by the X-ray imager 10 with various target objects arranged in various ways as training data to output a result of whether a target object is included in a surrounding image. Accordingly, by inputting the surrounding image cropped by the third image processing unit 225 to the second trained model 252, the determination unit 226 can obtain the result of whether the target object is included in the surrounding image as an output. In other words, since the determination operation by the determination unit 226 is performed in addition to the detection operation of the target object by the detection unit 224, the detection accuracy of the target object is enhanced.

The determination unit 226 outputs the determination result to the notification unit 227. The notification unit 227 is a functional unit that controls an output device such as the display 30 or the projector 42 to notify the detection result by the detection unit 224 based on the determination result by the determination unit 226.

For example, when the determination unit 226 determines that the surrounding image includes the object OJ (a lithium-ion battery in the present example), the notification unit 227 controls the display 30 to display a detection result image IMG 12a illustrated in FIG. 16B. The detection result image IMG 12a is an image in which a detection display object DD indicating the position of the object OJ detected by the detection unit 224 is superimposed on the image IMG 12 illustrated in FIG. 16A generated by the image processing by the second image processing unit 223. Further, when the determination unit 226 determines that the surrounding image includes the object OJ, the notification unit 227 controls the display 30 to display a detection result image IMG 12b illustrated in FIG. 17B. The detection result image IMG 12b is an image in which a detection display object DDa indicating the position and angle of the object OJ detected by the detection unit 224 is superimposed on the image IMG 12 illustrated in FIG. 17A generated by the image processing by the second image processing unit 223.

Furthermore, when the determination unit 226 determines that the surrounding image includes the target object, the notification unit 227 notifies the position of the target object by controlling the projector 42 to emit projection light to the conveyed object 60 including the target object conveyed on the conveyance device 41 based on the position and size of the target object detected by the detection unit 224, and thus controlling the projector 42 to project an irradiation area IRA, which is an image indicating the position of the target object as illustrated in FIG. 18. In this case, the notification unit 227 may control the projector 42 to emit projection light in conjunction with the operation of conveying the conveyed object 60 to form the irradiation area IRA based on the position and size of the target object detected by the detection unit 224 and the conveyance speed of the conveyance device 41. Thus, the notification unit 227 notifies the position of the target object in real time. When the determination unit 226 determines that the surrounding image includes the target object, the notification unit 227 may notify the position of the target object by controlling the projector 42 to emit projection light to the conveyed object 60 including the target object conveyed on the conveyance device 41 based on the position, size, and angle of the target object detected by the detection unit 224, and thus controlling the projector 42 to project an irradiation area IRA having a shape along the outer shape of the target object (e.g., a shape indicating the minimum circumscribed rectangle of the target object) as illustrated in FIG. 19. In this way, the information of the angle of the target object detected by the detection unit 224 can be used in the above-described processing by the third image processing unit 225 or the notification unit 227.

As illustrated in FIG. 20, the notification unit 227 may control the projector 42 to project the irradiation area IRA such as the minimum circumscribed rectangle of the target object to irradiate the approximate position and further project a position indicator PS by using light of a different color to indicate the pinpoint position of the target object (e.g., the position of the center of gravity of the area of the minimum circumscribed rectangle). In this case, the notification unit 227 may indicate the approximate position of the target object by expanding the irradiation area IRA over the full width of the conveyance device 41 as illustrated in FIG. 22. Thus, even when a large amount of non-combustible waste or the like overlaps with the target object, a certain level of visibility is achieved.

The notification unit 227 may enlarge or reduce the range of the irradiation area IRA using information on the thickness of non-combustible waste or the like that overlaps the target object. The thickness of non-combustible waste or the like is estimated from the color density of the non-combustible waste or the like in an image (e.g., an image obtained as a result of the image processing by the second image processing unit 223). FIG. 21A is a diagram illustrating a dual-energy X-ray image IMG 4 in which thin non-combustible waste overlaps a target object (e.g., a lithium-ion battery). FIG. 21B is a diagram illustrating a dual-energy X-ray image IMG 4a in which thick non-combustible waste overlaps the target object. For example, when non-combustible waste is on and below the target object, the distance between the target object and the X-ray source 11 varies. Accordingly, by projecting a wider range of the irradiation area IRA, the target object is inside of the irradiation area IRA even when there are some errors in the position of the target object detected by the detection unit 224.

When the removal device 50 is a robot arm, the removal device 50 can grip the target object in a more appropriate posture under control of the CPU 21 based on the angle of the target object detected by the detection unit 224.

Each functional unit of the target object detection program 22 of the object detection apparatus 20 illustrated in FIG. 9 is a conceptual representation of a function, and the functional configuration of the object detection apparatus 20 is not limited to that illustrated in FIG. 9. In other words, the functional units do not have to be implemented as distinct software modules as the blocks illustrated in FIG. 9. The functions of the functional units may be implemented as a whole by the object detection apparatus 20 executing the target object detection program 22. For example, multiple functional units illustrated as independent units in the target object detection program 22 in FIG. 9 may be configured as a single functional unit. Further, functions provided by a single functional unit of the target object detection program 22 illustrated in FIG. 9 may be divided and allocated to multiple functional units.

### Flow of Process by Object Detection System 1

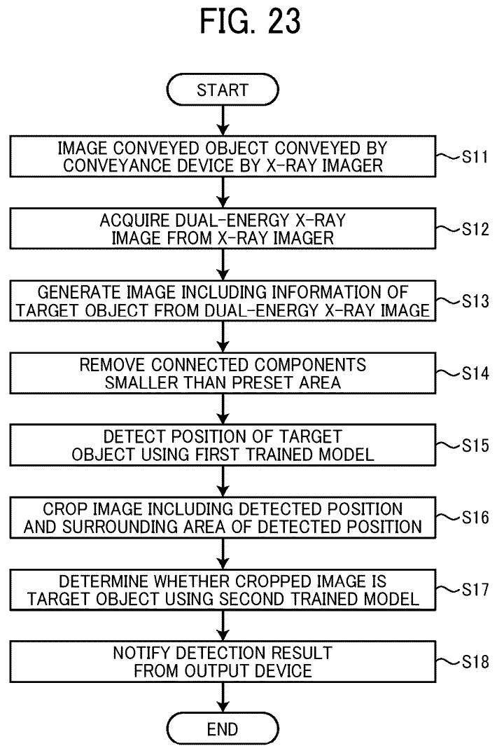

FIG. 23 is a flowchart illustrating an example of a flow of a process by the object detection system 1 according to the first example. The flow of the process by the object detection system 1 according to the present example is described below with reference to FIG. 23.

In step S11, the X-ray imager 10 images the conveyed object 60 conveyed by the conveyance device 41 and obtains a dual-energy X-ray image of the conveyed object 60. Then, the process proceeds to step S12.

In step S12, the image acquisition unit 221 of the object detection apparatus 20 acquires the dual-energy X-ray image of the conveyed object 60 captured by the X-ray imager 10 via an interface circuit. The image acquisition unit 221 outputs the acquired dual-energy X-ray image to the first image processing unit 222. Then, the process proceeds to step S13.

In step S13, the first image processing unit 222 of the object detection apparatus 20 generates an image in which a target object appears by performing image processing on the dual-energy X-ray image acquired by the image acquisition unit 221. The first image processing unit 222 outputs the generated image including the information of the target object to the second image processing unit 223. Then, the process proceeds to step S14.

In step S14, the second image processing unit 223 of the object detection apparatus 20 performs image processing for deleting connected components smaller than a preset area from the image generated by the first image processing unit 222. The second image processing unit 223 outputs the image obtained as a result of the image processing to the detection unit 224 and the third image processing unit 225. Then, the process proceeds to step S15.

In step S15, the detection unit 224 of the object detection apparatus 20 detects the position of the target object from the image obtained as a result of the image processing by the second image processing unit 223 by using the first trained model 251 that is pretrained to output the position of the target object and stored in the memory 25. The detection unit 224 outputs the detection result to the third image processing unit 225. The, the process proceeds to step S16.

In step S16, the third image processing unit 225 of the object detection apparatus 20 crops a surrounding image including the target object and a surrounding portion of the target object from the image generated by the image processing by the second image processing unit 223 based on the detection result of the target object detected by the detection unit 224. The third image processing unit 225 outputs the cropped surrounding image to the determination unit 226. Then, the process proceeds to step S17.

In step S17, the determination unit 226 of the object detection apparatus 20 determines whether the surrounding image cropped by the third image processing unit 225 includes the target object using the second trained model 252 stored in the memory 25. The determination unit 226 outputs the determination result to the notification unit 227. Then, the process proceeds to step S18.

In step S18, the notification unit 227 of the object detection apparatus 20 controls an output device such as the display 30 or the projector 42 to notify the detection result by the detection unit 224 based on the determination result by the determination unit 226.

In the above description, the second image processing unit 223 performs image processing for deleting connected components smaller than the preset area from the image generated by the first image processing unit 222. However, the image processing performed by the second image processing unit 223 is not limited to the above. The second image processing unit 223 may perform image processing for deleting connected components smaller than the preset area from the dual-energy X-ray image acquired by the image acquisition unit 221. In this case, the object detection apparatus 20 may not include the first image processing unit 222.

As described above, in the object detection apparatus 20 according to the present example, the image acquisition unit 221 acquires a dual-energy X-ray image based on two types of X-ray data from the X-ray imager 10, and the detection unit 224 detects the position of the target object using the first trained model 251 that is pretrained to output the position of the target object based on the dual-energy X-ray images acquired by the image acquisition unit 221. Thus, a target object is detected accurately based on the dual-energy X-ray image.

Further, in the object detection apparatus 20 according to the present example, the first image processing unit 222 generates an image in which a target object appears from the dual energy X-ray image acquired by the image acquisition unit 221, and the detection unit 224 detects the position of the target object using the first trained model 251 based on the generated image. Thus, the object is detected using the first trained model 251 from an image obtained by removing components other than the material of the target object from the dual-energy X-ray image, and therefore, the target object can be detected with higher accuracy.

Furthermore, in the object detection apparatus 20 according to the present example, the second image processing unit 223 deletes connected components smaller than a preset area from the image generated by the first image processing unit 222, and the detection unit 224 detects the position of the target object using the first trained model 251 based on the image from which the connected components have been deleted by the second image processing unit 223. Thus, the detection processing of the target object can be performed after removing components that may result in noise.

Furthermore, in the object detection apparatus 20 according to the present example, the detection unit 224 detects the position and the angle of the target object using the first trained model 251 that is pretrained to output at least one of the size of the target object and the angle of the target object in addition to the position of the target object based on the dual-energy X-ray image acquired by the image acquisition unit 221. Accordingly, the information on the size of the target object or the angle of the target object detected by the detection unit 224 is input from the detection unit 224 to the third image processing unit 225 or the notification unit 227, and thus can be used for the processing by the third image processing unit 225 or the notification unit 227.

In the object detection apparatus 20 according to the present example, the third image processing unit 225 crops an image including the position detected by the detection unit 224 and the surroundings of the detected position, and the determination unit 226 determines whether the image cropped by the third image processing unit 225 includes a target object using the second trained model 252 that is pretrained to output whether the target object is present based on the image. Thus, since the determination operation by the determination unit 226 is performed in addition to the detection operation of the target object by the detection unit 224, the detection accuracy of the target object is enhanced.

Furthermore, in the object detection apparatus 20 according to the present example, the notification unit 227 controls the output device to notify that the position of the target object has been detected by the detection unit 224. This enhances the workability of an operator.

Furthermore, in the object detection apparatus 20 according to the present example, the notification unit 227 controls the projector 42 as the output device to project an image indicating the position on the target object based on the position of the target object detected by the detection unit 224. Thus, the projector 42 emits projection light directly to the conveyed object 60 for which the target object is detected. This achieves high recognizability and makes the work of an operator easier.

### Second Example

The object detection apparatus 20 according to a second example is described below, focusing on differences from the object detection apparatus 20 according to the first example. In the first example, the operation in which the third image processing unit 225 crops the surrounding image of the target object from the image generated by the second image processing unit 223 based on the detection result of the target object detected by the detection unit 224 and the determination unit 226 determines whether the target object is included in the surrounding image using the second trained model 252 is described. In the second example, the configuration and operation in which the processing by the third image processing unit 225 and the determination unit 226 is omitted is described.

### Block Configuration of Object Detection Apparatus and Operation by Object Detection Apparatus

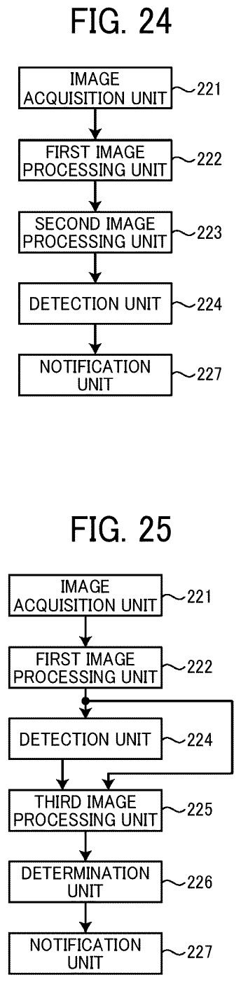

FIG. 24 is a diagram for explaining another form of the configuration of the functional blocks of the object detection apparatus 20 according to the second example. A block configuration of the object detection apparatus 20 and an operation by the object detection apparatus 20 according to the present example are described below with reference to FIG. 24.

As illustrated in FIG. 24, the object detection apparatus 20 includes the image acquisition unit 221, the first image processing unit 222, the second image processing unit 223, the detection unit 224, and the notification unit 227. The object detection apparatus 20 further includes the memory 25, although it is omitted in FIG. 24. The image acquisition unit 221, the first image processing unit 222, the second image processing unit 223, the detection unit 224, and the notification unit 227 are implemented by the CPU 21 of the object detection apparatus 20 executing the target object detection program 22.

In other words, compared to the object detection apparatus 20 according to the first example described above, the object detection apparatus 20 according to the present example does not include the third image processing unit 225 and the determination unit 226. The memory 25 does not store the second trained model 252.

The detection unit 224 detects the position of the target object from the image obtained as a result of the image processing by the second image processing unit 223 by using the first trained model 251 that is pretrained to output the position of the target object and stored in the memory 25. The specific operation by the detection unit 224 is the same or substantially the same as described in the first example. The detection unit 224 outputs the detection result to the notification unit 227.

The notification unit 227 controls an output device such as the display 30 or the projector 42 to notify of the detection result by the detection unit 224.

The object detection apparatus 20 according to the present example is useful in applications where the target object is a lithium-ion battery, the difficulty level of detection of the lithium-ion battery is relatively low because little inorganic material are mixed in, and it is determined that double-checking by re-determination is not needed, or where high processing speed is needed.

The object detection apparatus 20 according to the present example may have a configuration in which the first image processing unit 222 is omitted, a configuration in which the second image processing unit 223 is omitted, or a configuration in which both the first image processing unit 222 and the second image processing unit 223 are omitted. In other words, when the object detection apparatus 20 does not include the first image processing unit 222, the second image processing unit 223 may perform image processing of deleting connected components smaller than a preset area on the dual-energy X-ray image acquired by the image acquisition unit 221. When the object detection apparatus 20 does not include the first image processing unit 222, the image acquisition unit 221 may acquire an image that is equivalent to an image obtained as a result of the image processing by the first image processing unit 222 from the X-ray imager 10. When the object detection apparatus 20 does not include the second image processing unit 223, the detection unit 224 may input an image obtained as a result of the image processing by the first image processing unit 222 to the first trained model 251, and when a target object is detected in the image, obtain the position, size, angle, and type of the target object as an output. When the object detection apparatus 20 does not include the first image processing unit 222 and the second image processing unit 223, the detection unit 224 may input the dual-energy X-ray image acquired by the image acquisition unit 221 to the first trained model 251, and when a target object is detected in the image, obtain the position, size, angle, and type of the target object as an output.

### Third Example

The object detection apparatus 20 according to a third example is described below, focusing on differences from the object detection apparatus 20 according to the first example. In the first example, the operation in which the second image processing unit 223 removes a portion that results in noise from the image generated by the first image processing unit 222 is described. In the third example, an operation in which the second image processing unit 223 does not perform noise removal is described below.

Block Configuration of Object Detection Apparatus and Operation by Object Detection Apparatus FIG. 25 is a diagram for explaining another form of the configuration of the functional blocks of the object detection apparatus 20 according to the third example. A block configuration of the object detection apparatus 20 and an operation by the object detection apparatus 20 according to the present example are described below with reference to FIG. 25.

As illustrated in FIG. 25, the object detection apparatus 20 includes the image acquisition unit 221, the first image processing unit 222, the detection unit 224, the third image processing unit 225, the determination unit 226, and the notification unit 227. The object detection apparatus 20 further includes the memory 25, although it is omitted in FIG. 25. The image acquisition unit 221, the first image processing unit 222, the detection unit 224, the third image processing unit 225, the determination unit 226, and the notification unit 227 are implemented by the CPU 21 of the object detection apparatus 20 executing the target object detection program 22.

In other words, compared to the object detection apparatus 20 according to the first example described above, the object detection apparatus 20 according to the present example does not include the second image processing unit 223.

The first image processing unit 222 generates an image in which a target object appears by performing image processing on the dual-energy X-ray image acquired by the image acquisition unit 221. The specific operation by the first image processing unit 222 is the same or substantially the same as described in the first example. The first image processing unit 222 outputs the generated image including the information of the target object to the detection unit 224.

The detection unit 224 detects the position of the target object from the image obtained as a result of the image processing by the first image processing unit 222 by using the first trained model 251 that is pretrained to output the position of the target object and stored in the memory 25. The specific operation by the detection unit 224 is the same or substantially the same as described in the first example. The detection unit 224 outputs the detection result to the third image processing unit 225.

The third image processing unit 225 crops a surrounding image including the target object and a surrounding portion of the target object from the image generated by the first image processing unit 222 based on the detection result (e.g., the position and the size) of the target object detected by the detection unit 224. The third image processing unit 225 outputs the cropped surrounding image to the determination unit 226.

The object detection apparatus 20 according to the present example is useful in applications where the accuracy of detecting the target object is desired to be enhanced by the processing by the detection unit 224 and the determination unit 226, while the calculation cost of the image processing (the processing cost by the second image processing unit 223 in the present example) is desired to be reduced.

The object detection apparatus 20 according to the present embodiment may have a configuration in which the first image processing unit 222 is omitted too. In this case, the detection unit 224 may input the dual-energy X-ray image acquired by the image acquisition unit 221 to the first trained model 251, and when a target object is detected in the image, obtain the position, size, angle, and type of the target object as an output.

In the above-described examples, a lithium-ion battery is an example of an object to be detected. Alternatively, the object to be detected may be a dangerous object such as a lighter, a spray can, a gas cylinder, or an edged tool (e.g., a kitchen knife, a knife, or a cutter).

In each of the above-described examples, when at least one of the functional units of the object detection apparatus 20 is implemented by execution of a program, the program may be preinstalled in a read-only memory (ROM) or any desired memory of the object detection apparatus 20. Alternatively, in each of the above-described examples, the program executed by the object detection apparatus 20 may be stored in a computer-readable recording medium, such as a compact disc-read-only memory (CD-ROM), a flexible disk (FD), a compact disc-recordable (CD-ROM), or a digital versatile disk (DVD) in a file format installable or executable by the computer for distribution. Still alternatively, in each of the above-described examples, the program executed by the object detection apparatus 20 may be stored on a computer connected to a network such as the Internet and provided by being downloaded through the network. Yet alternatively, in each of the above-described examples, the program executed by the object detection apparatus 20 may be provided or distributed through a network such as the Internet. In each of the above-described examples, the program executed by the object detection apparatus 20 has a module configuration including at least one of the above-described functional units.

Regarding actual hardware, the CPU 21 reads the program from a memory such as the memory 25 and executes the program, thereby loading and generating each of the above-described functional units onto the main memory.

The technology according to the related art merely enhances visibility by pseudo-coloring based on a dual-energy X-ray image and has a drawback in that the technology cannot automatically detect a particular object.

An object detection apparatus, an object detection system, an object detection method, and a program according to an embodiment of the present disclosure can accurately detect a particular object based on a multi-energy X-ray image.

According to an aspect of the present disclosure, an object detection method includes acquiring a multi-energy X-ray image based on a plurality of types of X-ray data from an X-ray imager, generating a first image in which a target object appears, and detecting a position of the target object in the first image using a first trained model that is pretrained to output the position of the target object.

The above-described embodiments are illustrative and do not limit the present invention.

Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An object detection apparatus comprising circuitry configured to:
acquire a multi-energy X-ray image based on a plurality of types of X-ray data from an X-ray imager;
generate, by performing image processing on the multi-energy X-ray image, a first image in which a target object appears, wherein generating the first image includes extracting, from the multi-energy X-ray image, pixel values associated with a material of the target object;
delete, from the first image, connected components having an area smaller than a preset area; and
detect a position of the target object in the first image from which the connected components have been deleted, using a first trained model that is pretrained to output the position of the target object.

2. The object detection apparatus according to claim 1, further comprising a memory that stores association information associating each material with a corresponding range of pixel values of a multi-energy X-ray image,
wherein the circuitry generates the first image by extracting, from the multi-energy X-ray image, pixel values within the range associated with a material of the target object according to the association information.

3. The object detection apparatus according to claim 1, wherein the circuitry:
determines whether the number of the connected components is at least one and whether an aggregate area of the connected components is equal to or larger than the preset threshold area; and
when it is determined that the number of the connected components is at least one and the aggregate area is equal to or larger than the preset threshold area, deletes the connected components smaller than the preset area.

4. The object detection apparatus according to claim 1, wherein the first trained model is pretrained using at least one feature selected from the group consisting of a shape, X-ray attenuation amount, and material information of the target object in a multi-energy X-ray image.

5. The object detection apparatus according to claim 1, wherein the circuitry detects the position of the target object and the angle of the target object using the first trained model, and the first trained model is pretrained to output at least one of a size and an angle of the target object in addition to the position.

6. The object detection apparatus according to claim 1, wherein the circuitry is further configured to:
crop a second image including the detected position and a surrounding area of the detected position from the first image; and
determine, using a second trained model pretrained to output whether a target object is present in an image, whether the second image includes the target object.

7. The object detection apparatus according to claim 1, wherein the target object comprises a lithium-ion battery.

8. The object detection apparatus according to claim 1, wherein the circuitry is further configured to control an output device to notify that the position of the target object has been detected.

9. The object detection apparatus according to claim 8, wherein
the output device is a projector, and
the circuitry controls the projector to project an image indicating the detected position of the target object onto the target object based on the detected position.

10. An object detection system, comprising:
the object detection apparatus according to claim 1; and
an output device to notify that the position of the target object is detected by the circuitry of the object detection apparatus.

11. The object detection system according to claim 10, further comprising a removal device to remove, from a conveyance device, a conveyed object that is conveyed on the conveyance device and includes the target object whose position has been detected by the circuitry of the object detection apparatus.

12. A computer-readable, non-transitory medium storing a computer program, wherein the computer program causes a computer to execute a process, the process comprising:
acquiring a multi-energy X-ray image based on a plurality of types of X-ray data from an X-ray imager; and
generating, by performing image processing on the multi-energy X-ray image, a first image in which a target object appears, wherein generating the first image includes extracting, from the multi-energy X-ray image, pixel values associated with a material of the target object;
deleting, from the first image, connected components having an area smaller than a preset area; and
detecting a position of the target object in the first image from which the connected components have been deleted, using a first trained model that is pretrained to output the position of the target object.
